(19) United States
(12) Patent Application Publication
(10) Pub. No.: US 2008/0047591 A1
(43) Pub. Date: Feb. 28, 2008

(54) BELL CUP CLEANING SYSTEM AND METHOD

(76) Inventors: David M. Seitz, Riga, MI (US); Roger T. Cedoz, Curtice, OH (US)

Correspondence Address: TAYLOR & AUST, P.C.;ILLINOIS TOOL WORKS INC., 142 S. MAIN ST, PO BOX 560, AVILLA, IN, 46710, US

(21) Appl. No.: 11/830,288

(22) Filed: Jul. 30, 2007

Related U.S. Application Data
(60) Provisional application No. 60/840,083, filed on Aug. 25, 2006.

(51) Int. Cl. B08B 7/00; B05B 5/16; B08B 9/027

(52) U.S. Cl. 134/38; 134/22.18; 239/696

(57) ABSTRACT

A spray applicator cleaning system and a method includes a valve and control means for discharging air and solvent in alternating bursts to shaping air nozzles, a coating supply conduit and a dedicated cleaning nozzle on the applicator.

### CROSS-REFERENCE TO RELATED APPLICATIONS

This Non-Provisional Application claims the benefit of U.S. Provisional Application No. 60/840,083 filed Aug. 25, 2006.

### FIELD OF THE INVENTION

The present invention relates generally to coating applicators and, more particularly, the present invention relates to cleaning systems and methods for cleaning rotary atomizing applicators used to apply paint and other coatings.

### BACKGROUND OF THE INVENTION

Spray applicators are used to apply coatings of various types on objects during manufacture. Automobile vehicle bodies commonly are coated using robotic devices with spray applicators. The robot is programmed to perform a sequence of maneuvers and adjustments so that the vehicle body pieces are adequately and precisely covered in a rapid procedure with minimal coating waste.

Atomizing applicators are used to reduce the amount of over spray and further reduce waste. In a known atomizing applicator, a bell cup rotates at high speed, and the coating material, such as paint, is provided to the inside of the cup. As the paint or other coating moves outwardly and off the cup surface as a result of centrifugal force, the coating is atomized into a fine mist and is directed at the object to be coated. It is known to charge the atomized mist with electrical potential and to ground the object being coated so that the coating material is attracted to the object, further reducing over spray, improving coverage on irregularly shaped target objects and minimizing waste.

It is known to use air streams directed from the applicator to confine and direct the coating toward the object. The orifices and passages are of various diameters and lengths to provide the desired spray pattern shaping of the atomized spray. The orifices may be part of an air cap of a spray gun or part of the shaping air manifold of a rotary atomizer. Because the shaping air orifices have small diameters of some length, the orifices and passages are prone to plug with dirt or paint, which can alter the air flow and the desired function of the shaping air. The orifices can be cleaned manually by probing the orifice with a small pick to remove debris. However, manual cleaning can damage the edges and diameter surfaces, causing defective or undesired shaping air flows. Further, manual cleaning by probing is slow, requiring shutdown of the coating operation for a significant period of time.

Both the interior and the exterior of the bell cup require periodic cleaning. In some manufacturing procedures, such as for automobile vehicle bodies, it is known to have parts in random color sequences advancing along the manufacturing line. Thus, for each object to be coated it may be necessary to change the color of coating used from that used for the previous object. Accordingly, at least some surfaces of the applicator must be cleaned when a coating change is made.

Although the outside surface of the bell cup does not directly contact the coating that is applied, the outer surface can become contaminated with coating from the mist present in the coating booth. Residual amounts of coating, if allowed to accumulate on the outer bell cup surface, can contaminate subsequent coatings if dislodged, and can adversely alter operation of the applicator, including interfering with the shaping air streams directed along the outer edge of the bell cup. It is known to provide a cleaning station, and to move the applicator to the cleaning station at specific intervals to clean the back of the cup. Moving to a dedicated cleaning location can be time consuming, and cleaning at a cleaning station can be wasteful of cleaning solvents.

It is desirable to minimize the time needed for cleaning. Parts moving along a manufacturing line may be spaced by intervals of only a few seconds, and it is desirable to clean and prepare the applicator within the normal separation time so that the cleaning operation does not slow the overall speed of the assembly line significantly. Cleaning agents required for some coatings can be expensive to use. Accordingly, it is desirable to minimize the volume of cleaning agents used for cleaning. Decreasing the time required for cleaning and reducing the amount of cleaning agent required can significantly decrease costs and increase productivity of a coating operation. However, with rapidly drying coatings, cleaning can be difficult.

### SUMMARY OF THE INVENTION

The present invention provides a bell cup cleaning system and method that clean efficiently and quickly.

In one aspect thereof, the present invention provides a coating material applicator with an applicator body and an atomizing head at one end of the body. The head includes a bell cup having a base end, a forward end, an interior surface and an exterior surface. Also provided are a solvent source, a pressurized air source and fluid outlets on the inside and outside of the bell cup for supplying fluid to the interior surface and to the exterior surface. A fluids control system includes valves for controlling flow of solvent from the solvent source and air from the air source to the fluid outlets. A controller opens and closes at least some of the valves in controlled alternating pulses of air and solvent to at least one of the interior surface of the bell cup and the exterior surface of the bell cup

In another aspect thereof, the present invention provides a process for cleaning a coating material applicator having an atomizing head including a bell cup having a base end, a forward end, an interior surface, an exterior surface, and fluid outlets on the inside and outside of the bell cup. The process includes providing a flow of solvent from a solvent source, providing a flow of air from a pressurized air source and operating flow control means and controlling flow of solvent from the solvent source and air from the air source to at least some of the fluid outlets in controlled alternating discharges of air and solvent.

An advantage of the present invention is providing a cleaning system and method for a rotary atomizing applicator that cleans the fluid nozzles and passageways, the inner surface and the outer surface of the bell cup in a fast, efficient process requiring minimal time.

Another advantage of the present invention is providing a bell cup cleaning system and method that can be performed and operated between applicating steps without slowing manufacture and assembly processes significantly.

Still another advantage of the present invention is providing a rotary atomizing applicator cleaning system and method that cleans efficiently and quickly with a minimal amount of cleaning solvent, and can dislodge even difficult to remove coating.

Yet another advantage of the present invention is providing a bell cup cleaning system and method that provide an aggressive scrubbing action to clean passages quickly and thoroughly.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an elevational view of a rotary atomizing applicator having a cleaning system in accordance with the present invention;

FIG. 2 is an end view of the applicator shown in FIG. 1; and

FIG. 3 an enlarged fragmentary cross-sectional view of the applicator shown in FIGS. 1 and 2, also illustrating schematically a fluids control system of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

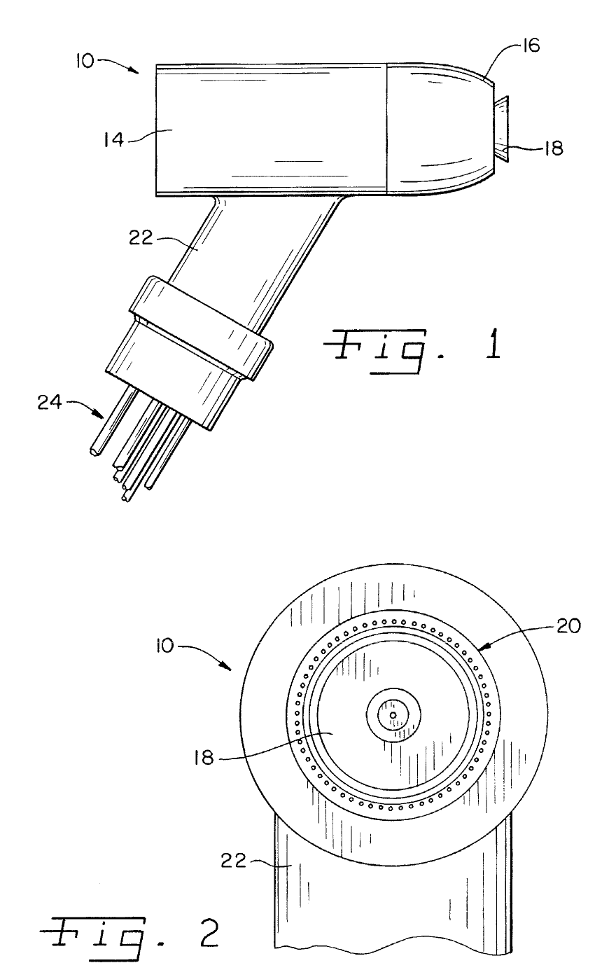

Referring now more specifically to the drawings and to FIG. 1 in particular, numeral 10 designates a rotary atomizing coating applicator having a fluids control system 12 (FIG. 3) that cooperate in bell cup cleaning in accordance with the present invention. Those skilled in the art will understand readily that the exemplary applicator 10 shown can be mounted on and operated by a robot (not shown) for performing controlled series of maneuvers to properly and consistently coat a series of objects in a manufacturing process. For example, such applicators are used to paint automobile vehicle bodies. However, applicators of this type also can be used for coating a variety of different objects with paint and other coatings. It should be further understood that the present invention works well with different styles and types of applicators and applicator 10 shown is merely one example of such a device. For example, the present invention can be used on applicators that are hand operated, or operated other than by a robot.

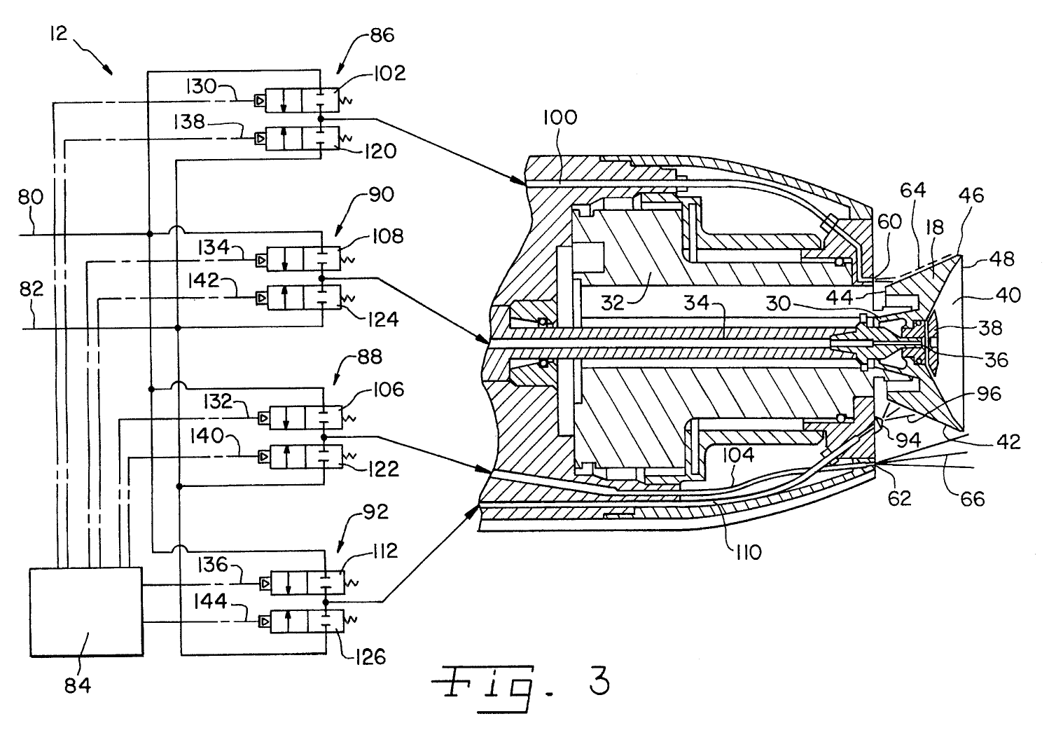

Applicator 10 includes a main body portion 14 having an atomizing head 16 on the forward end thereof. Head 16 includes a rotary bell cup 18 and a shaping air system 20 (FIG. 2) that cooperate one with the other in the application of coating, as will be explained more fully hereinafter. Additionally, applicator 10 includes a connector arm 22 by which various electrical, air and/or other systems and supplies are connected to or from a robot (not shown) for operation of applicator 10. The various systems connected to applicator 10 are indicated by the conductors and conduits generally indicated at numeral 24.

Referring now more specifically to FIG. 3, rotary bell cup 18 is disposed on an end 30 of an air turbine 32. Turbine 32 is operated by pressurized air to rotate at high speed, thus rotating bell cup 18 at high speed via end 30. A coating supply tube 34 extends through turbine 32 and has an outlet 36 in bell cup 18 whereby coating material, such as paint, from a supply (not shown) is supplied to and discharged in bell cup 18. A distributing body, splash plate, or other suitable structure or structures 38 and arrangements can be provided in bell cup 18, confronting or associated with supply tube outlet 36 or otherwise disposed to receive the coating material from supply tube 34 and to distribute the coating material evenly in bell cup 18. The general construction and operation of applicator 10, including the construction and operation of turbine 32, supply tube 34 and the deposit and handling of coating in bell cup 18 are known to those skilled in the art and will not be described in further detail herein.

Bell cup 18 in the exemplary embodiment shown is a cup or bowl-like body rotatable about its axis. Bell cup 18 has an interior surface 40 and an exterior surface 42. The cup-like shape of exemplary bell cup 18 provides a relatively narrow base end 44 and a broader forward end 46 terminating at a forward edge 48; however, it should be understood that bell cups of other shapes, such as, for example, substantially cylindrical shapes, also can be used advantageously in conjunction with the present invention. Interior surface 40 is substantially smooth, and expands outwardly from base end 44 to forward edge 48. Exterior surface 42 is also smooth, and expands outwardly from base end 44.

Shaping air system 20 includes a ring of shaping air inner nozzles 60 directed at exterior surface 42 near base end 44, and a ring of shaping air outer nozzles 62 directed forwardly adjacent forward end 46. Inner nozzles 60 are positioned behind bell cup 18, near base end 44 and are oriented in a manner such that a first pattern of inner fluid streams 64 is directed toward bell cup 18, from behind base end 44. In the exemplary arrangement shown, inner nozzles 60 are provided at evenly spaced locations, in a substantially circular pattern, behind and slightly outwardly of base end 44. Inner fluid streams 64 emitted from inner nozzles 60 approach exterior surface 42, and attach to surface 42 to follow along surface 42 toward forward end 46 and forward edge 48. As inner fluid streams 64 advance each stream follows the surface to which it attaches, and leaves exterior surface 42 at forward edge 48.

Outer nozzles 62 are disposed behind bell cup 18 and radially outward therefrom. Outer nozzles 62 are oriented in a manner such that a pattern of outer fluid streams 66 is directed forwardly toward the area at which inner fluid streams 64 separate from forward edge 48.

Fluids control system 12 is a flow control means for controlling flow of cleaning fluids to the interior and exterior of bell cup 18. Fluids control system 12 includes an air supply 80, a solvent supply 82 and a controller 84. Air supply 80, solvent supply 82 and controller 84 are connected to an inner shaping air valve set 86, an outer shaping air valve set 88, a coating supply valve set 90 and a dedicated cleaning nozzle valve set 92. One or more cleaning nozzle 94 is disposed behind bell cup 18 and directs a cleaning fluid spray 96 against exterior surface 42. In the exemplary embodiment spray 96 is aimed nearer base end 44 than forward end 46, but those skilled in the art will understand that spray 96 can be aimed at other positions along exterior surface 42 as well, and two or more cleaning nozzles 94 can be used aimed at different locations on exterior surface 42.

Air supply 80 is a source of pressurized air that can be the same source of pressurized air used to operate air turbine 32 and/or can be the source of pressurized air for shaping air supplied to nozzles 60, 62. Alternatively, air supply 80 can be a different source of pressurized air. Air supply 80 is connected in fluid flow communication to inner nozzles 60 through a conduit 100 and an air supply valve 102 in inner shaping air valve set 86. Air supply 80 is connected in fluid flow communication to outer fluid nozzles 62 through a conduit 104 and an air supply valve 106 in outer shaping air valve set 88. Further, air supply 80 is connected in fluid flow communication to coating supply tube 34 via an air supply valve 108 in coating supply valve set 90. Additionally, air supply 80 is connected in flow communication to cleaning nozzle 94 through a conduit 110 via an air supply valve 112 in cleaning nozzle valve set 92.

Solvent supply 82 is a source of solvent suitable for the coating being applied by applicator 10, to dilute and remove the coating from surfaces of applicator 10 which the coating contacts. Solvent supply 82 is connected in fluid flow communication to inner fluid nozzles 60 through conduit 100 and a solvent supply valve 120 in inner shaping air valve set 86. Solvent supply 82 is connected in fluid flow communication to outer fluid nozzles 62 through conduit 104 and a solvent supply valve 122 in outer shaping air valve set 88. Further, solvent supply 82 is connected in fluid flow communication to coating supply tube 34 via a solvent supply valve 124 in coating supply valve set 90. Additionally, solvent supply 82 is connected in flow communication to cleaning nozzle 94 through conduit 110 via a solvent valve 126 in cleaning nozzle valve set 92.

Air supply valves 102, 106, 108 and 112 and solvent supply valves 120, 122, 124 and 126 control the flow of air and a solvent, respectively, from the supplies there of to inner nozzles 60, outer nozzles 62, tube outlet 36 and cleaning nozzle 94, respectively. Each of the valves can be opened or closed independently of the others by operating signals from controller 84 to enable or block flow of the respective fluid, air or solvent, from the source thereof to the downstream nozzles 60, 62, 94 and outlet 36. Controller 84 can be a logic based analog or digital controller or simple electric controls for selectively opening and closing air supply valves 102, 106, 108 and 112 and solvent supply valves 120, 122, 124 and 126. Accordingly, controller 84 is connected to valves 102, 106, 108 and 112 and solvent supply valves 120, 122, 124 and 126 via signal lines 130, 132, 134, 136, 138, 140, 142 and 144, respectively. Those skilled in the art will understand readily that signals transmitted from controller 84 to air supply valves 102, 106, 108 and 112 and solvent supply valves 120, 122, 124 and 126 can be in the form of electrical signals, fluid signals in the way of pneumatic, hydraulic or other pressure signals or the like, and signal lines 130, 132, 134, 136, 138, 140, 142 and 144 can be electrical or other signal carrying wire-like signal lines, hydraulic lines or the like suitable for the signal being transmitted. Wireless communication from a transmitter that is connected to controller 84 to receivers associated with the valves also can be used.

During the application of coating, bell cup 18 is spun at high velocity through the operation of turbine 32, in known manner. Coating material, such as paint, is supplied from a source thereof (not shown) via supply tube 34 to the inside of bell cup 18 and is deposited on interior surface 40. Centrifugal force acting on the coating material causes the material to move along interior surface 40 toward forward edge 48. As the coating material advances off forward edge 48, the acceleration of the coating material is forward and outward relative to bell cup 18.

Shaping air system 20 is operated to confine the spray pattern of coating material being ejected from forward edge 48 and thereby improve the transfer efficiency of the coating being applied to an object being coated. As known to those skilled in the art, pressurized air is provided to inner nozzles 60 and outer nozzles 62 via conduits 100 and 104, respectively. Fluid streams 64 comprising air from inner nozzles 60 approach and attach to exterior surface 42, following along exterior surface 42 toward forward edge 48. Inner fluid streams 64 thereby operate against the coating material immediately as the coating material leaves forward edge 48. The spray pattern is confined and controlled immediately. Air streams 64 establish a barrier, or resistance to further outward expansion of the spray pattern ahead of bell cup 18. Pressurized air is also provided to outer nozzles 62 and outer fluid streams 66 comprising air directed from nozzles 62 toward forward end 46 of bell cup 18 reinforce the control from inner air streams 64 to control, confine and shape the pattern of coating moving toward the object to be coated.

As necessary, cleaning is performed in accordance with the present invention. Cleaning can be performed periodically to minimize build up, or, if coating materials are changed cleaning can be performed to prevent contamination of the new coating material with residue from the previous coating material. To perform a cleaning operation, the supply of coating to supply tube 34 is terminated. Air and solvent from air supply 80 and solvent supply 82, respectively, are provided via valve sets 86, 88, 90 and 92 for cleaning purposes. It should be understood that the cleaning processes to be described can be performed simultaneously or successively, and cleaning of exterior surface 42 can be performed less frequently than cleaning of the interior surface 40, if desired.

To clean interior surface 40, valves 108 and 124 are operated via control from controller 84, to provide alternating discharges of air and solvent. The air and solvent are not mixed, but are provided in bursts or pulses, one after another. Dilution of the film coating is performed by solvent and the diluted material is forced away by a following air blast. Additional discharges of air and solvent can follow to perform the desired cleaning. Pulsing air and solvent in this manner, referred to herein as an “air/solvent chop”, can cause vibrations in supply tube 34. These vibrations commonly referred to as “hammering,” serve to dislodge hardened or thickening accumulations of coating material, thereby performing an aggressive scrubbing action to clean the passage through supply tube 34, and the surfaces of distributing body 38 and interior surface 40.

Similarly, air supply valve 102 and solvent supply valve 120 of inner shaping air valve set 86 are pulsed in an air/solvent chop via control signals from controller 84 to provide alternating bursts or pulses of air and solvent through conduit 100 to inner shaping nozzles 60. The alternating bursts of air and solvent clean inner shaping nozzles 60, around and in which coating may have accumulated and interfered with air flow for shaping purposes. The hammering effect of the air/solvent chop dislodges coating that may have accumulated in nozzles 60. Additionally, the air and solvent emitted from inner shaping nozzles 60 attach to and follow exterior surface 42 for cleaning coating that may have deposited thereon.

Outer fluid nozzles 62 are cleaned in a similar manner. Valves 106 and 122 are opened and closed under control of controller 84 to provide successive, alternating bursts or pulses of air and solvent in an air/solvent chop. The alternating bursts of air and solvent clean outer fluid nozzles 62, around and in which coating may have accumulated and interfered with air flow for shaping purposes. The hammering effect of the air/solvent chop dislodges coating that may have accumulated in nozzles 62. Additionally, the air and solvent emitted from outer fluid nozzles 62 attach to and clean forward end 46 near forward edge 48, so that fluid flow off forward edge 48 and adjacent thereto are not impacted adversely by coating accumulation.

Supplying air and solvent to inner nozzles 60 and outer nozzles 62 cause the nozzles to remain open and clear so that the desired pattern of shaping air is emitted during coating application. The desired coating pattern control is retained by keeping fluid nozzles 60, 62 and forward edge 48 clean and free from accumulation. Effective cleaning with an air/solvent chop may require only minimal time. If exterior surface 42 requires additional cleaning, additional volumes of air and solvent spray 96 can be emitted from dedicated cleaning nozzle 94 via conduit 110. Valves 112 and 126 are opened and closed under control of controller 84 to provide successive, alternating bursts of air and solvent in an air/solvent chop. In one advantageous arrangement, cleaning nozzle 94 is positioned near base and 44 and provides a fan-like spray on exterior surface 42. It should be understood however that more than a single nozzle can be provided, and a single or multiple nozzles can be positioned to provide air and solvent at other positions on exterior surface 42, such as closer to forward end 46. Further, other emission patterns from such cleaning nozzles can be used. The particular arrangement shown is merely exemplary.

The periods of air and solvent supply during one air/solvent chop cycle can be varied, as can the number of cycles used in a cleaning procedure to obtain optimum cleaning. It is anticipated that the “air on” portion of a cycle often will be of shorter duration than the “solvent on” portion of the cycle, although the cycle portions can be of equal duration or with longer “air on” cycle portions as well. For example, for some paints it is believed a “solvent on” portion of one cycle may last about 1.7 seconds, and the “air on” portion of the cycle may last about 0.4 second; and that 3 or 4 cycles will be used. It is also contemplated that in some situations an overlap of the air and solvent portions of the cycle may be used; however, the predominant portion of the cycle will be air or solvent only during an air/solvent chop cleaning cycle. The hammering effect of the air/solvent chop cycle can be optimized by locating valve sets 86, 88, 90 and 92 close to the applicator so that the effect is not dampened significantly before reaching the passage or orifice to be cleaned. It may be advantageous to integrate the valve sets into the applicator to enhance the scrubbing action.

It should be understood that a single cycle in and air/solvent chop may begin with a burst of air to force coating through an opening or off a surface, or the cycle may begin with a burst of solvent for immediate dilution and washing, followed by an air blast for purging. As part of the cleaning process, fluids control system 12 can be operated to provide a mixture of air and solvent for a gentler cleaning of tube 34, distributing body 38, interior surface 40 and exterior surface 42.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A coating material applicator comprising:
an applicator body;
an atomizing head at one end of said body, including a bell cup having a base end, a forward end, an interior surface and an exterior surface;
a solvent source;
a pressurized air source;
fluid outlets on the inside and outside of said bell cup for supplying fluid to said interior surface and to said exterior surface; and
a fluids control system including valves for controlling flow of solvent from said solvent source and air from said air source to said fluid outlets, and a controller for opening and closing at least some of said valves in controlled alternating pulses of air and solvent to at least one of said interior surface of said bell cup and said exterior surface of said bell cup.

2. The coating material applicator of claim 1, said control system configured to provide said controlled alternating pulses of air and solvent to said interior surface.

3. The coating material applicator of claim 1, said control system configured to provide said controlled alternating pulses of air and solvent to said exterior surface.

4. The coating material applicator of claim 3, including a cleaning nozzle directing fluid to said exterior surface of said bell cup at a position nearer said forward end of said bell cup than said base end of said bell cup, and said control system configured to provide said controlled alternating pulses of air and solvent to said cleaning nozzle.

5. The coating material applicator of claim 3, including a cleaning nozzle directing fluid to said exterior surface of said bell cup at a position nearer said base end of said bell cup than said forward end of said bell cup, and said control system configured to provide said controlled alternating pulses of air and solvent to said cleaning nozzle.

6. The coating material applicator of claim 1, including a shaping air system having a plurality of shaping air nozzles directing fluid along said exterior surface, and said fluid control system configured to provide controlled alternating pulses of air and solvent through at least some of said shaping air nozzles.

7. The coating material applicator of claim 6, said shaping air system including a ring of inner nozzles and a ring of outer nozzles, and said fluid control system configured to provide controlled alternating pulses of air and solvent through at least some of said inner nozzles and at least some of said outer nozzles.

8. The coating material applicator of claim 7, including a coating supply tube through which coating material to be applied by said applicator is supplied to said bell cup interior surface, and said fluid control system configured to provide controlled alternating pulses of air and solvent through said supply tube.

9. The coating material applicator of claim 8, including a cleaning nozzle directing fluid to said exterior surface of said bell cup at a position nearer said forward end of said bell cup than said base end of said bell cup, and said control system configured to provide said controlled alternating pulses of air and solvent to said cleaning nozzle.

10. The coating material applicator of claim 8, including a cleaning nozzle directing fluid to said exterior surface of said bell cup at a position nearer said base end of said bell cup than said forward end of said bell cup, and said control system configured to provide said controlled alternating pulses of air and solvent to said cleaning nozzle.

11. The coating material applicator of claim 1, including a coating supply tube through which coating material to be applied by said applicator is supplied to said bell cup interior surface, and said fluid control system configured to provide controlled alternating pulses of air and solvent through said supply tube.

12. A process for cleaning a coating material applicator having an atomizing head including a bell cup having a base end, a forward end, an interior surface, an exterior surface, and fluid outlets on the inside and outside of the bell cup, said process comprising:
providing a flow of solvent from a solvent source;
providing a flow of air from a pressurized air source;
operating flow control means and controlling flow of solvent from the solvent source and air from the air source to at least some of the fluid outlets in controlled alternating discharges of air and solvent to at least one of the interior surface of the bell cup and the exterior surface of the bell cup.

13. The process of claim 12, including operating the flow control means and providing controlled alternating discharges of air and solvent to the interior surface.

14. The process of claim 12, including operating the flow control means and providing controlled alternating discharges of air and solvent to the exterior surface.

15. The process of claim 14, including directing fluid to the exterior surface of the bell cup at a position nearer the forward end of the bell cup than the base end of the bell cup through a dedicated cleaning nozzle, and providing controlled alternating discharges of air and solvent to the cleaning nozzle.

16. The process of claim 14, including directing fluid to the exterior surface of the bell cup at a position nearer the base end of the bell cup than the forward end of the bell cup through a dedicated cleaning nozzle, and providing controlled alternating discharges of air and solvent to the cleaning nozzle.

17. The process of claim 12, including operating the flow control means and providing controlled alternating discharges of air and solvent through at least some shaping air nozzles in the applicator.

18. The process of claim 12, including operating the flow control means and providing controlled alternating discharges of air and solvent through a supply tube directing coating to the interior surface of the bell cup.

19. The process of claim 12, including providing the controlled alternating discharges of air and solvent as distinct, discrete discharges by terminating a first discharge before commencing a following discharge.

20. The process of claim 12, including overlapping the controlled alternating discharges of air and solvent by commencing a following discharge before completely terminating an immediately preceding discharge.

21. The process of claim 12, including providing the discharge of solvent for a longer duration than the discharge of air.

22. The process of claim 12, including providing multiple cycles each including a discharge of solvent and a discharge of air.

23. The process of claim 12, including further operating the flow control means to provide a mixture of solvent and air to at least some of the fluid outlets by discharging air and solvent simultaneously.
